(19) United States
(12) Patent Application Publication
(10) Pub. No.: US 2016/0045842 A1
(43) Pub. Date: Feb. 18, 2016

(54) SYSTEM FOR INLINE PHASE SEPARATION OF A FLUID MIXTURE

(71) Applicant: AGAR CORPORATION Ltd., Grand Cayman (KY)

(72) Inventors: Joram AGAR, Grand Cayman (KY); Hector Alfredo VIALE-RIGO CAPUZZO, Simonton, TX (US)

(21) Appl. No.: 14/825,807

(22) Filed: Aug. 13, 2015

Related U.S. Application Data
(60) Provisional application No. 62/036,710, filed on Aug. 13, 2014.

(51) Int. Cl. B01D 17/02

(52) U.S. Cl. CPC B01D 17/0211

(57) ABSTRACT

A system for inline phase separation includes a pipe with an inlet and first outlet, a stagnation chamber, and a second outlet at a top of the stagnation chamber. The stagnation chamber is formed by a top panel, a first side panel, a second side panel and a bottom panel. The bottom panel remains flush with the pipe, and the top panel extends radially outward from a flow direction through the pipe. The cross-section formed by the panels is greater than the cross-section of the pipe, reducing flow speed in the stagnation chamber and allowing the fluid mixture to separate into phases from heavier on the bottom to lighter at the top. The second outlet can be used to remove lighter contents at the top, and analysis of the outlets allow for determination of density of the fluid mixture. The heavier contents return to the pipe through the first outlet.

### RELATED U.S. APPLICATIONS

The present application claims priority under 35 U.S.C. Section 119(e) from U.S. Provisional Patent Application Ser. No. 62/036,710, filed on 13 Aug. 2014, entitled “SYSTEM AND METHOD FOR INLINE PHASE SEPARATION IN A MIXTURE”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to an inline system and method to separate a phases in a flowing fluid mixture. In particular, the present invention relates to automated inline separators using gravity and density differences to remove a phase either the top or bottom or both of a stagnation chamber. The present invention also relates to determining density of the fluid mixture in the pipeline by measurement of separated phases from the stagnation chamber.

2. Description of Related Art Including Information Disclosed Under 37 CFR 1.97 and 37 CFR 1.98.

In the oil and gas industry, there are already conventional separator tank systems, which range from several gallons to several thousands of gallons in volume and store mixtures of oil, gas, water and other substances. The mixtures settle in the separator tank systems, such that phases stratify or separate by gravity or density. When sufficiently settled, a particular phase can be removed from the mixture. A conventional separator tank system for separating water and oil from a mixture comprises a tank body, an inlet for receiving the mixture, an interface detector, an outlet for oil, and an outlet for water. Vents to remove gas and coalesce are also in common usage.

There is a need for inline system for separation of phases, while the mixture is flowing. The conventional separator tank system requires the mixture to be delivered to the tank for settling. There is no flow, and the mixture stays stagnant. Pumps must move the mixture again after the settling and separation. Avoiding the stop in flow is an advantage of inline systems for separating phases from a mixture.

U.S. Patent Publication No. 2014/0008278 by Badr et al., published on Jan. 9, 2014, discloses an inline oil-water separator. The invention of this publication uses a small deep chamber with a depth of two diameters and a width of one diameter of the inline pipe member. There is a vortex and settling chamber, which uses density differences to select water from the mixture. A sensor detects when the water level is high enough, and opens a valve to remove the water from the settling chamber.

U.S. Pat. No. 7,516,794, issued to Gramme et al on Apr. 14, 2009, also describes an inline separator tank system. The invention includes a pipe section with specific flow path, which includes a major loop or bend with a radius greater than five times the pipe radius. A recess, preceding the bend, allows denser substances to settle and separate. For example, water can be a denser fluid in the mixture, which can be removed from the mixture at the recess.

In addition to gravity separation, there is separation by proportional composition. In treatment of oil and water mixtures, at any given point in the process cycle, the mixture is frequently processed, including initial separation and other treatments, resulting in an agitated mixture with small, semi-stable oil droplets, that are impractical to remove via gravity separation, as identified in “New Method for Improving Oil Droplet Growth for Separation Enhancement,” by Anne Finborud et al (Society of Petroleum Engineers, 1999). However, the relative proportion of these small droplets to the total oil flow remains relatively consistent so long as the process and oil source are not changed.

It is an object of the present invention to provide embodiments of a system and method for inline phase separation of a fluid mixture in a pipeline.

It is another object of the present invention to provide embodiments of a system and method for inline phase separation in a stagnation chamber in fluid connection with a pipe.

It is still another object of the present invention to provide embodiments of an inline stagnation chamber of a separator system with reduced turbulence.

It is still another object of the present invention to provide embodiments of an inline stagnation chamber sufficient time and volume for phase separation.

It is yet another object of the present invention to provide embodiments of an inline stagnation chamber with a configuration to decrease flow speed through the stagnation chamber.

It is yet another object of the present invention to provide embodiments of an inline stagnation chamber with a configuration to increase volume of the chamber as flow moves through the chamber.

It is yet another object of the present invention to provide embodiments of an inline stagnation chamber with a slanted surface for a rate of increase of chamber cross-section so as to avoid turbulence.

It is yet another object of the present invention to provide embodiments of an inline stagnation chamber with a curved surface for a rate of increase of chamber cross-section so as to avoid turbulence.

It is another object of the present invention to provide embodiments of a system and method for inline phase separation of a fluid mixture with a stagnation chamber and a transition chamber.

It is still another object of the present invention to provide embodiments of an inline stagnation chamber of a separator system with different flow characteristics in the stagnation chamber and the transition chamber.

It is yet another object of the present invention to provide embodiments of an inline stagnation chamber with a phase separation different from a phase separation in a transition chamber.

It is an object of the present invention to provide embodiments of a system and method for inline phase separation of a fluid mixture with attachments to affect flow characteristics, such as baffles, perforations, filters, and undulations.

It is an object of the present invention to provide embodiments of a system and method for inline phase separation of a fluid mixture with multiple phases, including but not limited to highly distinct phases, emulsions, and foams.

It is an object of the present invention to provide embodiments of a system and method for inline phase separation of a fluid mixture for detecting density.

It is another object of the present invention to provide embodiments of a system to detect parts per million (ppm) concentrations of components of the fluid mixture.

It is another object of the present invention to provide embodiments of a system and method for inline phase separation of a fluid mixture for detecting leaks in systems with positive pressure seals, including but not limited to systems in a gas sweetening process.

These and other objectives and advantages of the present invention will become apparent from a reading of the attached specification.

### SUMMARY OF THE INVENTION

Embodiments of the present invention include systems for inline phase separation of a fluid mixture through a pipe in a pipeline. The system may also be used to detect density of the fluid mixture. The system includes a pipe and a stagnation chamber. The pipe can be in fluid connection to the pipeline, such as a bypass for the fluid mixture flowing through the pipeline. The pipe is formed by a pipe body with an inlet at one end and a first outlet at an opposite end. The pipe body sets a flow direction of the fluid mixture from the inlet to the first outlet. The pipe body has a pipe cross-section set by tubular walls of the pipe body. The flow speed of the fluid mixture through the pipe is related to the pipe cross-section of the pipe body.

The stagnation chamber is located between the inlet and the first outlet. The stagnation chamber includes a top panel, a first side panel, a second side panel and a bottom panel. The panels define a chamber cross-section, which is greater than the pipe cross-section at the inlet of the pipe body toward the first outlet. The chamber cross-section expands greater than the pipe cross-section so as to reduce flow speed from the inlet to the first outlet. In some embodiments, the bottom panel remains flush with the pipe body so that the inlet, bottom panel, and first outlet are aligned. The first side panel and the second side panel extend radially outward or orthogonally from the bottom panel and the flow direction. The top panel connects the first and second side panels as top edges of the side panels angle away from the bottom panel. There is a second outlet on the top panel, which is in fluid connection with the inlet and the first outlet through the stagnation chamber. A segment of slope of the top panel forms an angle relative to the bottom panel, corresponding to the rate of decrease in the flow speed. The portion of the fluid mixture flowing through the second outlet allows determination of the density of the fluid mixture in the pipeline.

Embodiments of the present invention include the chamber cross-section expanding greater than the pipe cross-section so as to reduce flow speed and to allow for separation of the fluid mixture into phases. The flow speed can be slowed so that the fluid mixture is generally stagnant to allow for the sedimentation of heavier particles on the bottom of the stagnation chamber and lighter particles near the top of the stagnation chamber. The chamber cross-section can be greater than the pipe cross-section so as to reduce flow speed in the stagnation chamber to almost full stagnation at the second outlet. In some embodiments, the chamber cross-section can increase to 200-300% larger than the pipe cross-section or 350-400% larger than the pipe cross-section at the second outlet of the stagnation chamber. The segment of slope of the top panel can be angled at least 45 degrees relative to the bottom panel or range between 45 to 80 degrees from the bottom panel, such that the rate of expansion of the chamber cross-section has reduced or at least minimal turbulence.

Other embodiments of the present invention can include a window opening in the first side panel for visual observation of the phase separation. Still other embodiments include a baffle mounted within the stagnation chamber. The baffle can have an undulating surface and a shape corresponding to a shape of the first and second side walls of the stagnation chamber. Alternate baffles may also have perforations or filter elements or both. The second outlet at the top panel of the stagnation chamber can also have either a valve, a flow meter, a sensor or any combination thereof. Other meters and sensors can also be in fluid connection with the stagnation chamber.

Some embodiments of the system can include a transition chamber between the inlet of the pipe body and the stagnation chamber. The transition chamber is a smaller version of the stagnation chamber with panels defining a transition cross-section greater than the pipe cross-section. The transition chamber can reduce flow speed from the pipeline first. The stagnation chamber further slows the fluid mixture for the phase separation. The turbulence can be more controlled in the stagnation chamber from the transition chamber. There can also be accessories in fluid connection with the transition chamber, such as a removal outlet in the bottom of the transition chamber so that the heaviest particles are more immediately removed from the slowed fluid mixture. A depth sensor may also be in fluid connection with the transition chamber. Various other accessories can be attached to measure and detect the separating fluid in the transition chamber.

### BRIEF DESCRIPTION OF THE DRAWINGS

FIG. 1 is a schematic view of an embodiment of a system for inline phase separation of the present invention, showing a configuration of the stagnation chamber with a transition chamber.

FIG. 2 is a schematic view of an embodiment of the system for inline phase separation as bypass in fluid connection with a pipeline.

FIG. 3 is an upper perspective view of the embodiment of the system for inline phase separation, as shown in FIG. 2.

FIG. 4 is a side elevation view of the embodiment of the system for inline phase separation, as shown in FIG. 2.

FIG. 5 is a graph illustration of the diesel volume fraction at the second outlet of an embodiment of the present invention, according to FIG. 1.

FIG. 6 is a graph illustration of the diesel volume fraction at the second outlet of another embodiment of the present invention, according to FIGS. 3 and 4.

FIGS. 7a, 7b, 7c, 7d, and 7e are schematic views of embodiments of the system for inline phase separation, showing variations of baffles.

### DETAILED DESCRIPTION OF THE DRAWINGS

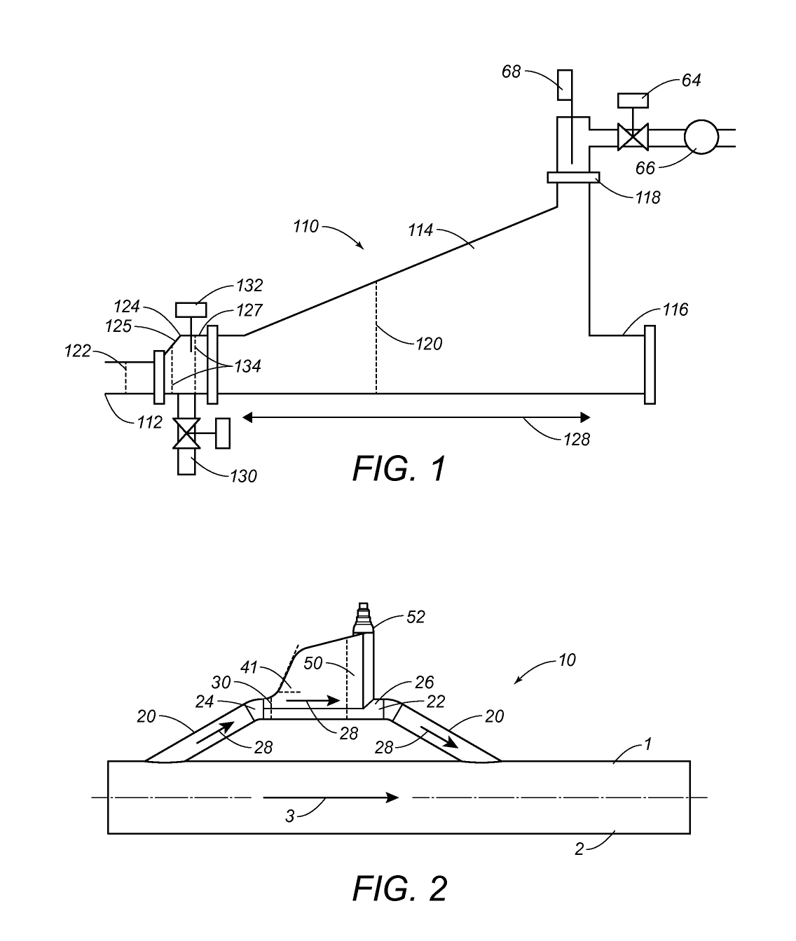

FIG. 1 shows an embodiment of a system 110 with an inlet 112, a stagnation chamber 114, a first outlet 116, and a second outlet 118. In this embodiment, the stagnation chamber 114 has a chamber cross-section 120 increasing from the pipe cross-section 122 at the inlet 112 toward the first outlet 116. The stagnation chamber 114 is a flow speed reduction zone 128. The diameter and volume of the stagnation chamber 114 increases in order to slow a fluid mixture flowing through the pipe. FIG. 1 shows a configuration of the stagnation chamber 114 with the chamber cross-section 120 expanding greater than the pipe cross-section 122 of the pipe body so as to reduce flow speed and to separate phases of the fluid in the stagnation chamber 114. The length of the stagnation chamber 114 can be increased so as to increase the flow speed reduction zone 128. As the chamber cross-section 120 continues to expand, the fluid mixture can be slowed to almost complete stagnation, which can allow settling of particles and phase separation. The second outlet 118 at the top of the stagnation chamber 114 can be used remove the lighter materials separated to the top of the stagnation chamber 114.

FIGS. 2-4 show another embodiment of the system 10 for inline phase separation. FIG. 2 shows the overall system 10 in fluid connection with a pipeline 1. A fluid mixture 2 in the pipeline 1 has a flow direction 3. In the oil and gas industry, this fluid mixture 2 can include water, oil, gas, and other substances. The mixture may even include solid particles suspending in the fluid. Emulsions and rock fragments or other drilling byproducts can also be present. The system 10 is placed inline with the pipeline 1, so that the same fluid mixture 2 of the pipeline flows through the system 10 for inline phase separation. FIG. 2 shows the system 10 connected as a bypass to the pipeline

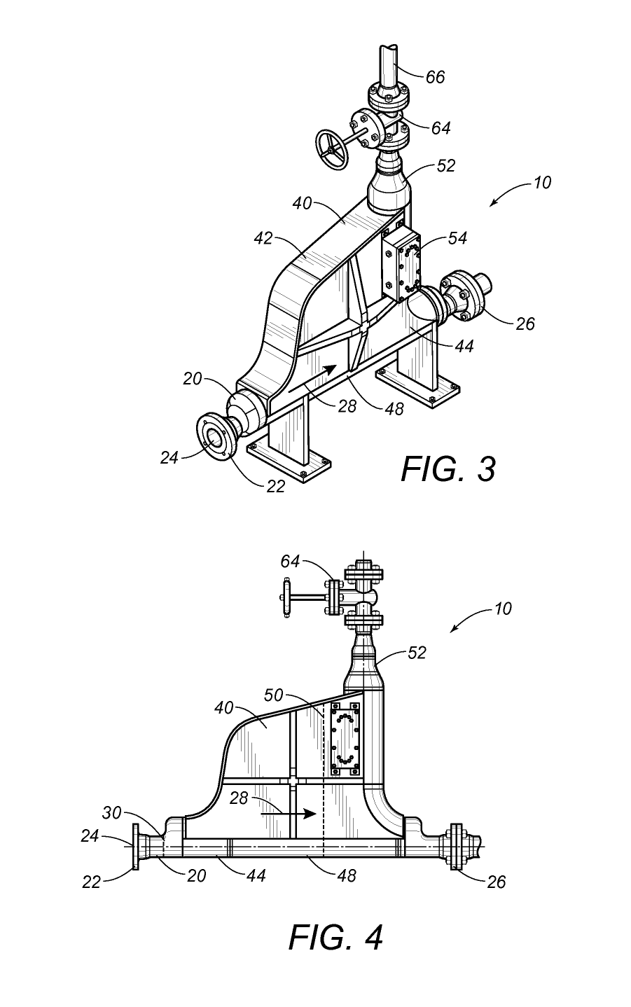

This embodiment of the system 10 includes a pipe 20 comprised of a pipe body 22 with an inlet 24 at one end and a first outlet 26 at an opposite end. The pipe body 22 has a flow direction 28 from the inlet 24 to the first outlet 26 and a pipe cross-section 30 set by walls 32 of the pipe body 22. The flow direction 28 can be aligned with the flow direction 3 in the pipeline 1 of FIG. 2. The fluid mixture enters the system 10 through the pipe body 22. FIGS. 2-4 also show the stagnation chamber 40 between the inlet 24 and the first outlet 26. In FIGS. 3-4, the stagnation chamber 40 is comprised of a top panel 42, a first side panel 44, a second side panel 46 and a bottom panel 48. In this embodiment, the bottom panel 48 is flush with the pipe body 22. In alternative embodiments, the bottom of the stagnation chamber 40 must be aligned with the pipe body 22 in the flow direction 28, while the stagnation chamber 40 can be extended radially outward in any direction orthogonal to the axis defined by the flow direction 28. FIGS. 2-4 show a vertical orientation, but other orientations of the stagnation chamber 40 are possible for different flow speed and separation parameters, such as inverted orientation for dropping heavier particles. In the embodiment of FIGS. 3-4, the first side panel 44 and the second side panel 46 extend orthogonally upward from the bottom panel 48 and the flow direction 28. The top panel 42, the first side panel 44, the second side panel 46 and the bottom panel 48 define a chamber cross-section 50. The chamber cross-section 50 defined by the panels 42, 44, 46, and 48 starts the same as the pipe cross-section 30 and increases from the inlet 24 toward the first outlet 26. FIGS. 3-4 show a second outlet 52 on the top panel 42 and in fluid connection with the inlet 24 and the first outlet 26 through the stagnation chamber 40. The chamber cross-section 50 of the stagnation chamber 40 expands greater than the pipe cross-section 30 of the pipe body 22 so as to reduce flow speed and to separate phases of any fluid in the stagnation chamber 40. The stagnation chamber 40 is a flow speed reduction zone to allow the separation of phases in the fluid mixture.

The present invention is a system 10 with a particular stagnation chamber 40 having a chamber cross-section 50 expanding greater than the pipe cross-section 30 so as to reduce flow speed in the stagnation chamber 40. In some embodiments, there can be almost full stagnation of the fluid mixture at the second outlet 52. The stagnation chamber 40 of the present invention can particularly defined by the chamber cross-section 50 having a cross-section 200-300% larger than the pipe cross-section 30. Alternatively, the chamber cross-section 50 can have an end cross-section 54 that is 350-400% larger than the pipe cross-section 30 at the second outlet 52. Also, the greatest height or distance of the stagnation chamber away from the pipe body and the height of the pipe body can be 2.5 times greater than the height of the pipe body.

Furthermore, the stagnation chamber 40 can be defined by the top panel 42 having a segment of slope 41 forming an angle of at least 45 degrees relative to the bottom panel 48. The first side panel 44 and the second panel 46 have angled edges matching the top panel 42 from the inlet 24 to the second outlet 52. Alternatively, the top panel 42 can have a segment of slope forming an angle between 45 to 80 degrees relative to the bottom panel 48. The rate of decrease in flow speed allows for separation of the phases of the fluid mixture with reduced turbulence. The embodiment of the present invention controls the increase in chamber cross-section 50. The panels 42, 44, 46, 48 define the particular stagnation chamber 40 for a sufficient rate of slowing of flow speed without undue turbulence, which would prevent the phase separation. The relationship between the top panel 42, bottom panel 48 and the pipe body 22 is an embodiment of the present invention for consistent and significant phase separation.

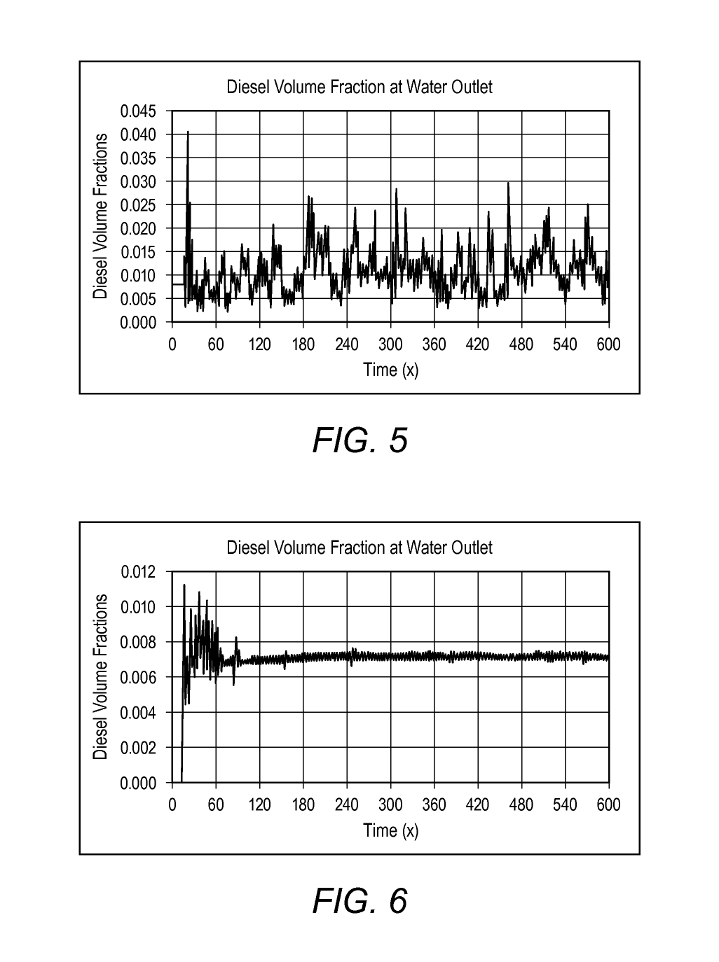

FIGS. 5 and 6 are graph illustrations of the present invention. FIG. 5 shows the diesel volume fraction at the second outlet, corresponding to a system 110 of FIG. 1. As long as there is space along the pipeline, the system 110 can be stretched to eventually slow the fluid mixture, until the fluid mixture can settle. FIG. 5 shows the result of different amounts of diesel being separated at the second outlet. Any increase in a chamber cross-section from a pipe cross-section would decrease flow speed, and any flow speed could be achieve by manipulating the length and chamber cross-section size. FIG. 5 shows one embodiment, according to FIG. 1 with a longer stagnation chamber. FIG. 6 shows the result of the amount of diesel being separated at the second outlet 52 of an embodiment of the system 10 of FIGS. 3 and 4. The amount of diesel separable from the fluid mixture is stable and consistent according to the panels, 42, 44, 46, 48 and pipe body 22 as now claimed. The present invention includes the relationship of the top panel 42, bottom panel 48 and pipe body 22 to have an effective and consistent separation at the second outlet 52. The effective inline phase separation, which can reliably detect density of the fluid mixture are the advantages and functionality of the present invention beyond simply slowing flow speed. The structures of the present invention define a specific flow speed slowing, set by the relationship of the recited structures.

The present invention shows the effective separation as the consistent volume of a phase to be extracted from the stagnation chamber. FIG. 5 shows the difficulty of achieving the consistency. Embodiments of the present invention for FIG. 6 show the successful achievement of the effective separation. The diesel volume fraction within the range of about 0.002-0.003 contrasts the range of 0.025. The structures of the present invention control the flow speed set by the relationship of the recited structures. The arrangement and combination elevates beyond the prior art and known natural phenomenon of phase separation in a chamber. Even if phases regularly settle and separate, the present invention sets structures and sequence for effective separation.

The dimensions of the stagnation chamber 40 are sufficient to settle phases in the fluid mixture by gravity, density or other separation means. The interior volume with the top panel 42 can be curved, slanted or a combination of surfaces. This embodiment of the stagnation chamber 40 is also compatible with the pre-existing technologies for phase separation and oil removal that are used to improve phase separation and oil removal, including: (1) mechanical, including kinetic manipulation, such as sonic agitators to accumulate larger oil particles, baffles, parallel plate and screen coalescers, or centrifuging; (2) thermal, primarily heating; (3) chemical additions to change surface tension and enhance separation; and (4) electrostatics, commonly used with desalters. The materials used may be modified for improved performance, for example surface treatments, for example hydrophobic or oleophobic coatings.

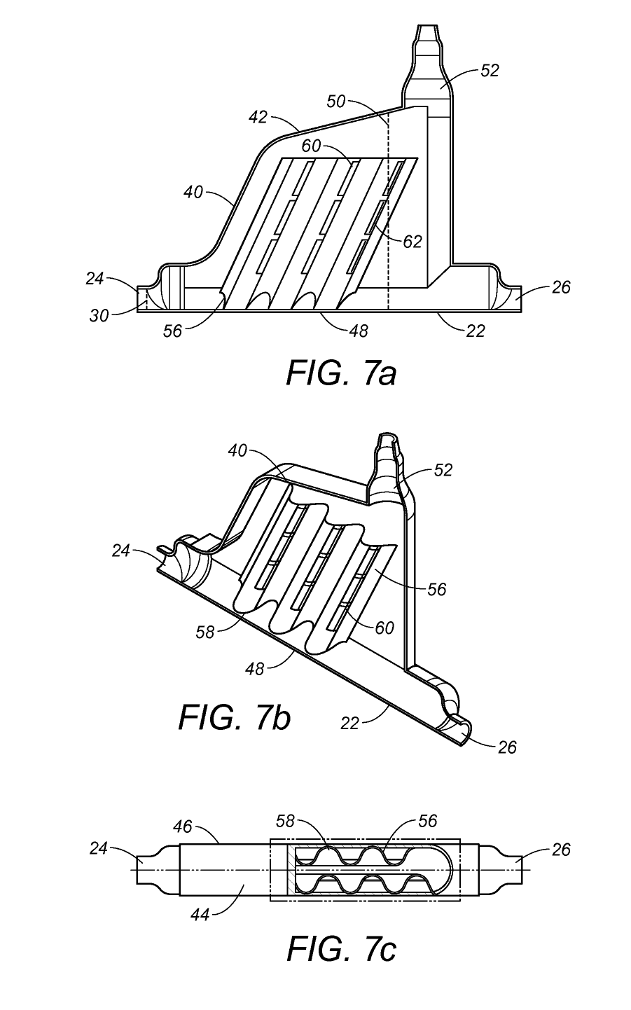

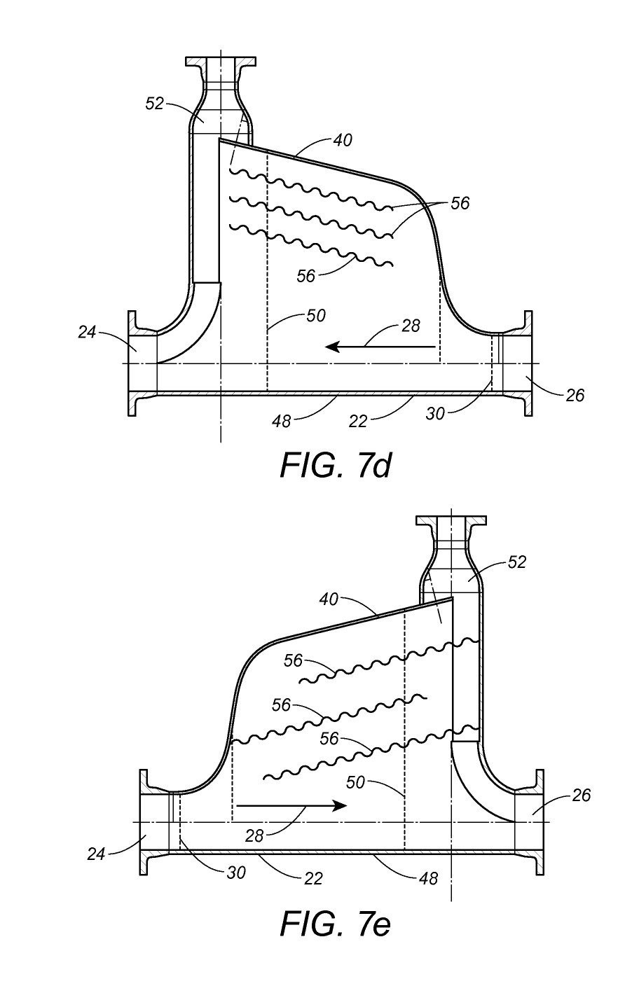

Embodiments of the system 10 can have various accessories. FIGS. 3 and 4 show a window 54 in the first side panel 44. The window 54 can be a housing to allow visual inspection or other instrumentation to detect the phase separation. The window 54 is set closer to the second outlet 52 and first outlet 26. FIGS. 7a-e show the stagnation chamber 40 with a baffle 56 in various forms and positions. The baffle 56 can be mounted within the stagnation chamber 40 and extends into the chamber cross-section 50. FIGS. 7a-3 shows the baffle 56 mounted on the bottom panel 48 and extends into the stagnation chamber 40 toward the top panel 42. FIGS. 7a, 7b, and 7c shows the baffle 56 with an undulating surface 58 and having a shape corresponding to a shape of the first side wall 44 and the second side wall 46 of the stagnation chamber 40. FIGS. 7a and 7b show embodiments of the baffle 56 with perforations 60 or filter elements 62 or both. The baffle 56 further controls flow speed in the stagnation chamber 40 for more consistent phase separation. The fluid mixture encounters the baffle 56 to further reduce flow speed and control separation through the stagnation chamber 40. The flux of the flow speed in the pipe body 22 to the flow speed in the stagnation chamber 40 is without undue turbulence, while still making the deceleration effective. FIGS. 7d and 7e show different orientations of the baffle 56 as sheets in different alignments with the top panel 42. The flow path can be changed in these embodiments. Other accessories include a valve 64, flow meter 66 and sensor 68, as in FIG. 1 and FIG. 3 (valve 64). At the second outlet 52 of the top panel 42, the accessories can control and monitor the separated phase flowing from the fluid mixture. In density detection, the sensor 68 can measure diesel volume fraction, as in FIGS. 5 and 6.

FIG. 1 shows another aspect of embodiments of the system 110. In some systems 110, there is a transition chamber 124. The transition chamber 124 can have attachments and accessories, similar to the stagnation chamber 40, such as a removal outlet 130 for sludge, and a depth sensor 132. Once the fluid mixture slows in the transition chamber 124, some phases may quickly separate to the bottom, where that phase can be removed. Heavy solid particles can be more quickly removed or at least separated. The transition chamber 124 is between the inlet 112 and the stagnation chamber 114. The transition chamber 124 can be comprised of a transition side walls (only shown in schematics in FIG. 1). The construction can be similar to the panels 42, 44, 46, and 48 of a stagnation chamber 40 in some embodiments. Similarly, a bottom of the transition chamber 124 can be flush with the pipe body 22 and the bottom panel 48 of the stagnation chamber 40 and aligned with the flow direction through the pipe body 22. In embodiments with accessories, the removal outlet 130 can be in the bottom of the transition chamber 124. Alternatively, a depth sensor 132 can be in fluid connection with the transition chamber 124. The transition chamber also extends radially outward from the the pipe body and matches extension of the stagnation chamber 40. FIGS. 3-4 show a transition chamber 124 in a vertical orientation with the stagnation chamber 40 in a vertical orientation. The transition side walls form a transition cross-section 134 from the inlet 112 toward the stagnation chamber 114 so as to reduce flow speed. The stagnation chamber 114 has a flow speed lower than the transition chamber 124, wherein the pipe cross-section 122 is smaller than the transition cross-section 134, and the transition cross-section 134 is smaller than the chamber cross-section 124. In this embodiment of the system 110, the transition chamber 124 enables the effective phase separation and density detection in the particular flow speed changes of the top transition panel, the bottom transition panel, the stagnation chamber, and the pipe body.

The transition chamber 124 of FIG. 1 is shown with a transition expanding portion 125 and a transition set portion 127. The transition expanding portion 125 is between the inlet 112 and the transition set portion 127, and the transition set portion 127 is between the transition expanding portion 125 and the stagnation chamber 40. The flow speed through the transition expanding portion 125 decreases, but remains stable in the transition set portion 127. The transition set portion 127 has a set transition cross-section greater than the pipe cross-section 122 of the pipe body.

In some embodiments, the transition expanding portion 125 and transition set portion 127 can also be applied to the stagnation chamber 40 as an expanding portion and a set portion. The expanding portion is between the inlet and the set portion, and the set portion is between the expanding portion and the second outlet. The flow speed through the expanding portion decreases, but remains stable in the set portion. The set portion has a chamber cross-section greater than the pipe cross-section of the pipe body and the transition cross-section of the transition chamber. In still further embodiments, the order can be reversed, so that the set portion stabilizes flow speed before the lighter phases are separated at the second outlet. For example, there is less turbulence when the flow speed is no longer changing. The chamber cross-section expands along the top panel in different effective configurations for the effective separation supported in FIG. 6. The present invention includes the stagnation chamber 40 to control the reduction in flow speed to an effective separation of phases. The transition chamber further controls the flow speed reductions for effective phase separation and density detection.

The present invention can achieve inline separation for a fluid mixture with a quick separation of 95% of the oil/water mixture, but a somewhat slower separation for the remainder, or a fluid mixture with high or low water-cut, where the oil should be very dry. For example, in the case of 95% water-cut, the separator is targeting the 5% oil cut. The fluid mixture can be slowed so that the 5% of the oil can be occupied in the stagnant region of the tank, which could be 40% of the tank volume. Thus, the effective residence time is 0.4/0.05=8 times that of a traditional tank, and so a much smaller tank can be used.

The present invention can also function as a ppm meter, as shown in FIG. 1 and FIG. 3. By separating out the smaller faction of the oil, and using either a meter or timing how long the removal valve is open, the amount of oil can be found. The initial line samples the main flow and is expanded from {d} to {D=3 d}. The tank length is 10 D to allow for a greater time for oil particles to rise. The tank height is 4 D. The outlet is controlled by a water-cut sensor which activates when it senses 95% oil, opening the outlet valve, and closes at 80% oil. The separation depends partially on a principle of proportional composition. So, by an initial calibration, a process calibration factor can be determined to evaluate ppm composition. In the case of ppm measurement, either a representative sample of the flow or the entirety of the flow may pass through the invention. The oil may be removed or returned to the flow depending on which is more desirable. Additionally, the inline separation of the present invention facilitates desalter applications. The smaller volume compared to conventional desalters would allow for advantages including greater electrostatics efficiency.

The present invention provides embodiments of a system for inline phase separation of a fluid mixture with a stagnation chamber. The fluid mixture in a pipeline can be diverted to a pipe of the system of the present invention for phase separation and analysis, such as density detection. There is slower flow speed and reduced turbulence to allow for sufficient time and volume for an effective and consistent phase separation. The top panel, bottom panel, and pipe body control the rate of decrease of flow speed and separation time by increasing volume in relation to the pipe body as the fluid mixture flows further through the stagnation chamber. Various embodiments further control the effective separation with segments of slope for the rate of increasing cross-section and baffles to divert and lengthen flow paths. Some embodiments include a transition chamber with another set of top panels and bottom panels to insure the effective separation without undue turbulence in the stagnation chamber. There are differences in a phase separations in the transition chamber and the stagnation chamber, such that some heavy particles can be quickly removed from the transition chamber.

Embodiments also include accessories, such as baffles, perforations, filters, and undulations. These accessories can further control the flow speed and separation of phases. The duration in the stagnation chamber and lengthening of the flow path can refine the separation at the second outlet. Sensors, valves, and meters at the outlets further monitor the phase separation for the effective separation. The present invention shows the effective separation as the consistent volume of a phase to be extracted from the stagnation chamber. The fluid mixture with multiple phases can include highly distinct phases, emulsions, and foams. Use of the system is a method for inline phase separation of a fluid mixture for detecting density. The system can detect parts per million (ppm) concentrations of components of the fluid mixture. Additionally, the collected data at the outlets can be used to detect leaks in systems with positive pressure seals, including but not limited to systems in a gas sweetening process.

The foregoing disclosure and description of the invention is illustrative and explanatory thereof. Various changes in the details of the illustrated structures, construction and method can be made without departing from the true spirit of the invention.

We claim:

1. A system for inline phase separation, comprising:
a pipeline comprised of a pipe body with an inlet at one end and a first outlet at an opposite end, said pipe body having a flow direction from said inlet to said first outlet and a pipe cross-section set by walls of said pipe body;
a stagnation chamber between said inlet and said first outlet, said stagnation chamber being comprised of a top panel, a first side panel, a second side panel and a bottom panel, said bottom panel being flush with said pipe body, said first side panel and said second side panel extending radially outward from said bottom panel and said flow direction, said top panel, said first side panel, said second side panel and said bottom panel defining a chamber cross-section, said chamber cross-section increasing from said pipe cross-section at said inlet toward said first outlet; and
a second outlet on said top panel and in fluid connection with said inlet and said first outlet through said stagnation chamber,
wherein said chamber cross-section of said stagnation chamber expands greater than said pipe cross-section of said pipe body so as to reduce flow speed and to separate phases of fluid in said stagnation chamber.

2. The system, according to claim 1, wherein said chamber cross-section has a cross-section 200-300% larger than said pipe cross-section.

3. The system, according to claim 1, wherein said chamber cross-section has an end cross-section 350-400% larger than said pipe cross-section at said second outlet.

4. The system, according to claim 1, wherein a greatest height of said stagnation chamber and a height of said pipe body at said inlet is 2.5 times larger than said height of said pipe body at said inlet.

5. The system, according to claim 1, wherein said top panel has a segment of slope forming an angle of at least 45 degrees relative to said bottom panel, said first side panel and said second panel having angled edges corresponding to said top panel from said inlet to said second outlet.

6. The system, according to claim 1, wherein said top panel has a segment of slope forming an angle between 45 to 80 degrees relative to said bottom panel, said first side panel and said second panel having angled edges corresponding to said top panel from said inlet to said second outlet.

7. The system, according to claim 1, further comprising:
a baffle being mounted within said stagnation chamber and extending into said chamber cross-section of said stagnation chamber.

8. The system, according to claim 7, wherein said baffle is comprised of an undulating surface.

9. The system, according to claim 7, said baffle having a shape corresponding to a shape of said first side wall and said second side wall of said stagnation chamber.

10. The system, according to claim 7, wherein said baffle has perforations.

11. The system, according to claim 1, further comprising:
a transition chamber between said inlet and said stagnation chamber, said transition chamber having transition side walls forming a transition cross-section from said inlet toward said stagnation chamber so as to reduce flow speed, said transition cross-section being smaller at said inlet than at said stagnation chamber;
wherein said stagnation chamber has a flow speed lower than said transition chamber, wherein said pipe cross-section is smaller than said transition cross-section, and wherein said transition cross-section is smaller than said chamber cross-section.

12. The system, according to claim 1, wherein said chamber cross-section is comprised of an expanding portion and a set portion, said expanding portion being between said inlet and said set portion, said set portion being between said expanding portion and said second outlet, wherein flow speed through said stagnation chamber decreases in said expanding portion, wherein flow speed through said stagnation chamber is constant in said set portion, and wherein said set portion has a set cross-section greater than said pipe cross-section of said pipe body.

13. The system, according to claim 11, wherein said transition cross-section is comprised of a transition expanding portion and a transition set portion, said transition expanding portion being between said inlet and said transition set portion, said transition set portion being between said transition expanding portion and said stagnation chamber, wherein flow speed through said transition chamber decreases in said transition expanding portion, wherein flow speed through said transition chamber is constant in said transition set portion, and wherein said transition set portion has a set transition cross-section greater than said pipe cross-section of said pipe body.

14. The system, according to claim 1, further comprising a valve at said second outlet in said top panel of said stagnation chamber.

15. The system, according to claim 1, further comprising a flow meter at said second outlet in said top panel of said stagnation chamber.

16. The system, according to claim 1, further comprising a sensor at said second outlet in said top panel of said stagnation chamber.

17. A system for inline phase separation and density detection, comprising:
a pipeline comprised of a pipe body with an inlet at one end and a first outlet at an opposite end, said pipe body having a flow direction from said inlet to said first outlet and a pipe cross-section set by walls of said pipe body;
a stagnation chamber between said inlet and said first outlet, said stagnation chamber being comprised of a top panel, a first side panel, a second side panel and a bottom panel, said bottom panel being flush with said pipe body, said first side panel and said second side panel extending radially outward from said bottom panel and said flow direction, said top panel, said first side panel, said second side panel and said bottom panel defining a chamber cross-section, said chamber cross-section increasing from said pipe cross-section at said inlet toward said first outlet; and
a second outlet on said top panel and in fluid connection with said inlet and said first outlet through said stagnation chamber,
wherein said chamber cross-section expands greater than said pipe cross-section so as to reduce flow speed in said stagnation chamber to almost full stagnation at said second outlet.

18. The system, according to claim 17, wherein said top panel has a segment of slope forming an angle between 45 to 80 degrees with said bottom panel, said first side panel and said second panel having angled edges corresponding to said top panel from said inlet to said second outlet.

19. The system, according to claim 17, further comprising:
a baffle being mounted within said stagnation chamber and extending into said chamber cross-section of said stagnation chamber.

20. The system, according to claim 17, further comprising:
a transition chamber between said inlet and said stagnation chamber, said transition chamber having transition side walls forming a transition cross-section from said inlet toward said stagnation chamber so as to reduce flow speed, said transition cross-section being smaller at said inlet than at said stagnation chamber;
wherein said stagnation chamber has a flow speed lower than said transition chamber, wherein said pipe cross-section is smaller than said transition cross-section, and wherein said transition cross-section is smaller than said chamber cross-section.
